(19) United States
(12) Patent Application Publication
(10) Pub. No.: US 2010/0316836 A1
(43) Pub. Date: Dec. 16, 2010

(54) MEMBRANE PANEL

(75) Inventor: Volker Benz, Hochst (DE)

Correspondence Address: CONNOLLY BOVE LODGE & HUTZ, LLP, P O BOX 2207, WILMINGTON, DE, 19899, US

(73) Assignee: Bayer Sheet Europe GmbH, Darmstadt (DE)

(21) Appl. No.: 12/517,970

(22) PCT Filed: Nov. 23, 2007
(86) PCT No.: PCT/EP2007/010170

§ 371 Date: Jul. 6, 2009

(30) Foreign Application Priority Data
Dec. 5, 2006 (DE) 10 2006 057 187.8

(51) Int. Cl. E04C 2/00; E04C 2/54; E04D 3/35; B32B 7/00; B32B 27/00

(52) U.S. Cl. 428/100; 428/99

(57) ABSTRACT

The present invention relates to a sheet, characterized in that two opposite surfaces have elements which can transmit significant tensile forces in the plane of the sheet.

The present invention relates to a sheet, characterized in that two opposite surfaces have elements which can transmit significant tensile forces in the plane of the sheet.

Sheets which carry loads under flexural stress are known from the prior art. Such sheets carry loads, such as the intrinsic weight of the sheet itself and surface loads, e.g. due to wind or snow, under flexural stress and are regularly supported at the edges in a holding device against forces acting perpendicularly to the sheet. If the load acting on the sheet is too high, the sheet must be stabilized accordingly by further supports, such as e.g. stays, so that it does not typically slip from the support or kink in the middle of the span. The larger the sheet, the more total load must be carried. As a result, a considerable number of supports are as a rule required for larger constructions.

Sheets which have elements on two opposite surfaces which serve to join adjacent sheets are also known from the prior art. Thus e.g. DE 31 26 440 describes sheets which serve as infill panels for stiffening between two otherwise unstable profiles, i.e. in a similar manner to wind bracings. DE-OS 2125725 describes sheets of plastic having elements where only a joint connection is achieved, and the main load-bearing direction runs in the direction of the joint (longitudinal direction). DE-OS 27 52 286 likewise describes sheets of plastic having elements with which only a joint connection is achieved, and where no load initiation at the joint into the sub-structure takes place. U.S. Pat. No. 4,573,300 also described only sheets of plastic having elements where only a joint connection is achieved, the main load-bearing direction is in the longitudinal direction and where no load initiation at the joint into the sub-structure takes place. The prior art described therefore comprises only support widths in the transverse direction of the sheets of up to approx. 1.20 m.

It has now been found that with the sheet according to the invention higher span widths (support widths) can be achieved, since the sheet, without hereby being restricted to the theory, can carry loads not primarily under flexural stress, like a conventional sheet, but predominantly under tensile stress.

In this context, sheet is to be understood as meaning a substantially rectangular sheet of plastic. This can be a monolithic sheet, also called a solid sheet, or a multi-shell sheet, also called a multi-wall sheet. Such sheets are employed e.g. in wall or roof systems where large load-bearing widths are to be spanned, e.g. modern architecture, such as, for example, stadia. The technical requirements and features of such sheets are described in European Technical Approval Guideline 010 (STAG 010).

In a preferred embodiment, the invention relates to twin-wall sheets or multi-wall sheets. Such sheets of polycarbonate, but also of other plastics, are sufficiently known and are produced by means of extrusion. They comprise the particular chords on the top and bottom, which are spaced by a plurality of usually parallel bars at the particular distance, in the present case in the region of 10 mm or more, and have corresponding, often rectangular hollow spaces. Twin-wall sheets have a top chord and a bottom chord and the bars lying in between. Multi-wall sheets have, in addition to the top chord and a bottom chord and the bars, further inner chords (intermediate chords) which usually run parallel to the top chord and bottom chord. Triple-wall or four-wall sheets etc. e.g. are referred to, according to the number of chords. In addition to twin-wall sheets or multi-wall sheets with rectangular geometries, there are also corresponding sheets with chords arranged at an angle, which are e.g. also called framed sheets.

Twin-wall or multi-wall sheets according to the present invention have a thickness of more than 4 mm, preferably 8 to 40, particularly preferably 15 to 30 mm. The thickness here describes the distance between the outer chords (top and bottom chord). Total thickness or sheet height can also be referred to.

The present invention furthermore relates to such a sheet, characterized in that it has a span width of more than 1.2 m, preferably more than 1.5 m, very preferably more than 2.0 m and in particular more than 2.5 m.

Conventional weights per unit area are in the region of more than 1.3 kg/m², preferably 1.7 to 6, particularly preferably 2.5 to 5, in particular 2.6 to 4 kg/m².

Conventional thicknesses of the top and bottom chord are in the range of from 0.5 to 4, particularly preferably 0.5 to 1.5 mm. The bars and any intermediate chords present are as a rule significantly thinner, e.g. 0.1 to 1.5 mm. Conventional sheet widths, which are determined by the width of the extrusion die, are between 100 and 3,000 mm. Conventional sheet lengths are in the range of from 500 mm to 15,000 mm.

Polycarbonate is sufficiently known as a thermoplastically processable plastic. Polycarbonate plastics are predominantly aromatic polycarbonates based on bisphenols, in particular bisphenol A.

The production of multi-wall sheets e.g. of polycarbonate is sufficiently known and is described, for example, in “Technische Thermoplaste, Kunststoff Handbuch 3/1, Hanser Verlag”, Munich, in particular pages 248-257.

The process for the application of additional layers, e.g. of polycarbonate, to one or both surfaces of the top or bottom chord is likewise sufficiently known (see e.g. EP-A 368 094, EP-A 372 213, EP-A 0 548 822). In this context, the covering layer can contain e.g. UV absorbers or pearlescent pigments and can be applied by the route of coextrusion or by lacquering or by reverse roll coating.

“Two opposite edges” here are to be understood as meaning two edges which run parallel to one another or substantially parallel to one another. More preferably, the edges are parallel, it being possible for deviations of 5-10% to be tolerated.

In one embodiment, “elements” means specific shapings which serve the purpose of fixing the sheet to tensile stress in a correspondingly shaped support (positive tensile connection). Shaping here means that the sheet itself is constructed such that the two opposite surfaces merge into such shapings. For example, the sheet can have a depression, e.g. a groove or a hook-like groove, parallel to these surfaces. A shaping in the support which is substantially complementary in structure can then engage accordingly into this groove. In another embodiment, the shaping is an undercut connection.

In another embodiment, after its production the sheet is provided with a device which serves the purpose of fixing the sheet to tensile stress in a correspondingly shaped support. Such devices can be, for example, tracks, which run along the opposite surfaces. Such devices can in principle be made of any material which can accommodate the tensile forces, such as e.g. metal or plastic. Known joining techniques can be used to join the device to the sheet, such as e.g. gluing, welding, riveting, screwing or clamping.

In one embodiment, the element is symmetric over the length of the sheet, i.e. is uniformly configured along the top opposite surfaces along the entire length. In a further embodiment, the element is configured along 50%, preferably along 90% of the length of the surface. In a further embodiment, the elements are symmetrical on both sides.

“Have” here means that the said opposite surfaces and the elements can be connected to one another in any desired form; the elements can be part of the sheet and therefore of the surface, e.g. in the case of an extruded sheet can have been extruded together with this, or the elements can also have been applied subsequently, thus e.g. such as a track or strip of the material of the sheet or of another material.

In the present connection, the feature “can transmit significant tensile forces in the plane of the sheet” means that the elements can transmit tensile forces between the sheet and a suitable holding device which holds the element. Tensile forces are regarded as significant here if a significant portion of the intrinsic weight of the sheet itself and surface loads, e.g. due to wind or snow, can thereby be carried, in particular more than 60%, preferably more than 70%, particularly preferably more than 80%, in particular more than 90%. The sheet can thus to a certain extent be tensioned like a membrane between the two opposite surfaces, or can become tensioned itself under load (similarly to a cable construction). In one embodiment, the fixing device is configured such that material stresses of 20 MPa are not exceeded.

It is to be pointed out that in multi-wall sheets from the prior art, the main load-bearing direction is in the longitudinal direction, and only an insignificantly portion is carried in the transverse direction, while in the sheets according to the invention the main load-bearing direction is in the transverse direction.

The surface loads are removed into the support. It has been found that the sheets according to the invention cannot slip from the support, since they are anchored, and that no kinking of the sheet occurs in the middle of the span, since scarcely any flexural stress takes place in the middle of the span.

In one embodiment, the sheet is transparent to light. The term “transparent to light” relates to the visible spectral range; the wavelength range of from 380 to 780 nm, in particular the wavelength of 550 nm serves for the characterization. The light transparency, which is designated T here, is predominantly symbolized by τD65 in the scientific literature. The base material and the binder should have a light transparency T of at least 50%, preferably 60 to 94%.

Known thermoplastics are suitable for production of the sheet. For example, polycarbonate, polystyrene, polymethyl methacrylate, polyethylene, polypropylene, polyvinyl chloride, polyester, acrylo-butadiene-styrene and blends therefore can be used. These are described in Saechtling, “Kunststoff Taschenbuch” 28th ed. (2001), chapter 4, Hanser Verlag, Munich, Vienna

The present sheet is therefore particularly suitable for the production of load-bearing systems which can be employed as roof or wall systems, in particular as illumination systems. The present invention therefore also provides a connector profile which can accommodate the shaping of the sheet. Such a connector profile is preferably constructed as a two-part track, the lower part of which is laid on a suitable support. The sheet is then laid on this lower part, and the upper part of the connector profile is fixed to the lower part, in order to fix the sheet in between.

In one embodiment, the invention therefore also relates to an illumination system comprising a sheet according to the invention which is transparent to light and a connector profile.

1.-14. (canceled)

15. A sheet which comprises two opposite surfaces which have elements which can transmit significant tensile forces in the plane of the sheet.

16. The sheet according to claim 15, wherein the elements are hooks.

17. The sheet according to claim 15, wherein the elements are undercut connections.

18. The sheet according to claim 15, wherein the elements are made of the same material as the sheet.

19. The sheet according to claim 18, wherein the elements are part of the sheet.

20. The sheet according to claim 19, wherein the elements are extruded together with the sheet.

21. The sheet according to claim 15, wherein the sheet is made of polycarbonate.

22. The sheet according to claim 15, wherein the sheet is a multi-wall sheet.

23. The sheet according to claim 15, wherein the sheet is a solid sheet.

24. The sheet according to claim 15, wherein 2 pairs of opposite surfaces have elements which can accommodate tensile forces in the plane of the sheet.

25. The sheet according to claim 15, wherein the sheet has a span width of more than 1.2 m.

26. The sheet according to claim 15, wherein the sheet has a span width of more than 1.5 m.

27. The sheet according to claim 15, wherein the sheet has a span width of more than 2.0 m.

28. The sheet according to claim 15, wherein the sheet has a span width of more than 2.5 m.

29. A load-bearing system comprising the sheet according to claim 15 and a connector profile.

30. An illumination system comprising the sheet according to claim 15 which is transparent to light and a connector profile.
